(19) United States
(12) Patent Application Publication
(10) Pub. No.: US 2008/0149848 A1
(43) Pub. Date: Jun. 26, 2008

(54) Sample Inspection Apparatus and Sample Inspection Method

(75) Inventors: Hiroyuki Suzuki, Hitachinaka (JP); Masahiro Sasajima, Hitachinaka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi High-Technologies Corporation, Tokyo (JP)

(21) Appl. No.: 11/961,348

(22) Filed: Dec. 20, 2007

(30) Foreign Application Priority Data
Dec. 21, 2006 (JP) 2006-343877

(51) Int. Cl. G01N 23/00

(52) U.S. Cl. 250/443.1

(57) ABSTRACT

The present invention provides an inspection apparatus capable of suppressing leak electric current to a specimen and a probe, and thus capable of measuring highly sensitive electrical characteristics, when the specimen is heated by a heater. A specimen heating unit that heats a specimen is configured of: a heater; a grounded metallic shield, which coats the heater as electrically insulated; and an insulation sheet disposed on a side of the metallic shield facing the mounted specimen. Likewise, a probe heating unit is configured of: a heater; a grounded metallic shield, which coats the heater as electrically insulated; and an insulation sheet.

### CLAIM OF PRIORITY

The present application claims priority from Japanese application JP 2006-343877 filed on Dec. 21, 2006, the content of which is hereby incorporated by reference into this application.

### BACKGROUND OF THE INVENTION

1. Field of the Invention

The present invention relates to an inspection apparatus and an inspection method for measuring electrical characteristics of a minute region of an electronic device.

2. Description of the Related Art

Inspection apparatuses such as an electron beam inspection apparatus (hereinafter simply referred to as an “EB inspection apparatus”) and a probe inspection apparatus have heretofore been known as inspection apparatuses for detecting an electrical defect in a microelectronic circuit formed on a semiconductor chip. The EB inspection apparatus is an inspection apparatus that locates an electrical failure in a large-scale integrated circuit (hereinafter simply referred to as an “LSI”) by irradiating a spot to be measured with an electron beam, utilizing a phenomenon in which the amount of secondary electron emissions arising from the spot to be measured varies depending on the voltage value of the spot to be measured. The probe inspection apparatus is an inspection apparatus that measures electrical characteristics of the LSI by bringing plural probes or mechanical probes arranged in accordance with the positions of characteristic measuring pads of the LSI, into contact with the measuring pads or plugs. When using the EB inspection apparatus or the probe inspection apparatus, an operator of the inspection apparatus performs manual operation to check the contact positions of the probes, while viewing an image such as an image of wiring through an optical microscope or a scanning electron microscope (hereinafter simply referred to as a “SEM”).

Recently, a circuit pattern formed on a semiconductor device such as the LSI has become more complicated, higher performance has led to higher operating frequencies, and the range of use environments has become wider. Hence, measures have had to be taken to cope with heat. Against this background, the design and development of the semiconductor device require a procedure that involves heating an LSI specimen, bringing the probe into direct contact with an object to be tested, and analyzing the electrical characteristics at a heating temperature. For example, Japanese Patent Application Laid-Open Publication No. 2000-258491 discloses a method in which, while the specimen is heated in a vacuum by a heating-cooling mechanism, the probe is moved by a probe driving mechanism to thereby measure the electrical characteristics of the specimen. Japanese Patent Application Laid-Open Publication No. Hei 6-74880 discloses that a specimen is integrally constituted with a heater and an insulation sheet interposed between the specimen and the heater. Thus, adiabatic efficiency and electrical insulation properties are improved, while temperature control is facilitated. There is a disclosure indicating that the insulation sheet having a thickness of 100 μm or more produces leak electric currents on the order of a several tens of picoamperes (pA) from the heater. Japanese Patent Application Laid-Open Publication No. 2004-227842 discloses that both the specimen and the probe are heated to substantially the same temperature.

### SUMMARY OF THE INVENTION

It is essential that failure analysis be done with high sensitivity on a cell-by-cell basis, since the recent circuit pattern formed on the semiconductor device such as the LSI has become finer and more complicated. The method disclosed in Japanese Patent Application Laid-Open Publication No. 2000-258491 has difficulty in measuring the electrical characteristics with high accuracy on the order of a picoampere (pA) or lower. Specifically, in this method, since the specimen is merely placed directly in the heating-cooling mechanism such as the heater, the leak electric current arising from the heater makes the measurement difficult. When this method is followed to bring the probe into contact with a minute region on the specimen on the order of a several tens of nanometers (nm) to be observed by the SEM or the like, a drift can possibly occur due to temperature variations or temperature differentials resulting from heating. This drift causes the problem of offsetting the contact position, or causes damage to a probe point, thus making it impossible to accurately measure desired electrical characteristics. In addition, when the LSI or the like to be tested—as being in direct contact with the probe—is driven by a high clock, a great deal of heat can possibly be produced by the device. This temperature differential often leads to a drift of a several hundreds of nanometers (nm), which makes the probe point damaged. The method disclosed in Japanese Patent Application Laid-Open Publication No. Hei 6-74880 has to fabricate a heater unit integrally formed with each specimen, because the specimen, the heater and the insulation sheet are integrally formed with one another. For the recent finer semiconductor circuit pattern, acceptable leak electric current for high-sensitivity measurement is of the order of a picoampere (pA) or lower. It may be possible that the thickness of the insulation sheet is increased to suppress the leak electric current, but this configuration leads to deterioration in thermal efficiency, and leads to further difficulty in the temperature control. Thus, it is impossible to measure the electrical characteristics with high sensitivity. The method disclosed in Japanese Patent Application Laid-Open Publication No. 2004-227842 cannot measure the electrical characteristics with high accuracy if the heater is used for a variable temperature mechanism, because the probe is not provided with electrical insulation for a member for measuring the electrical characteristics.

An object of the present invention is to provide an inspection apparatus, such as a probe inspection apparatus, designed to measure electrical characteristics with high sensitivity by bringing a probe into direct contact with an LSI or the like. The inspection apparatus suppresses leak electric current from a heater to a specimen or the probe, when the specimen and the probe are heated by the heater. Thus, the inspection apparatus according to the present invention enables measuring highly sensitive electrical characteristics. Another object of the present invention is to provide the inspection apparatus which enables achieving measurement with good operability and high reliability without damage to the probe, even at the occurrence of a change in the position of the specimen due to heat.

According to the present invention, a specimen is heated by transferring heat—generated by a heater provided for a specimen stage—through a grounded metallic shield, which coats the heater as electrically insulated, and through an insulation member such as an insulation sheet disposed on a side of the metallic shield facing the mounted specimen. Moreover, a probe is heated by transferring heat—generated by a heater—through a grounded metallic shield, which coats the heater as electrically insulated, and through an insulation member such as an insulation sheet disposed on a side of the metallic shield facing the probe.

Moreover, expansion of a specimen having a fine circuit wiring pattern caused by self-heating of the specimen is detected by monitoring the height of the specimen. If a change in the height of the specimen caused by the self-heating is detected, control is performed so that the probe is withdrawn. In this way, damage to the probe is prevented.

The present invention can suppress the leak electric current from the heater to the specimen, and thus perform an inspection with high sensitivity, when the specimen is heated to measure electrical characteristics of the specimen relative to a temperature thereof.

### BRIEF DESCRIPTION OF THE DRAWINGS

FIG. 1 is a schematic view of a principal part of a SEM type inspection apparatus according to the present invention.

FIG. 2 is a diagram showing coordinate systems for movements of large and small stages, and of a probe stage.

FIG. 3 is a schematic view showing the configurations of a specimen heating unit and a probe heating unit of the SEM type inspection apparatus according to the present invention.

FIG. 4 is a schematic diagram showing the configuration of the specimen heating unit.

FIG. 5 is a diagram showing electrical characteristics of an embodiment of the present invention and the prior art.

FIG. 6 is a cross-sectional view showing a probe withdrawing mechanism.

FIG. 7 is a flowchart of probe withdrawal control.

FIG. 8 is a schematic view of another embodiment of the present invention.

FIG. 9 is a schematic view of the embodiment of the present invention shown in FIG. 8.

### DETAILED DESCRIPTION OF THE PREFERRED EMBODIMENTS

Embodiments of the present invention will be described below with reference to the drawings. A SEM type inspection apparatus using an electron beam is herein given as an example of an inspection apparatus.

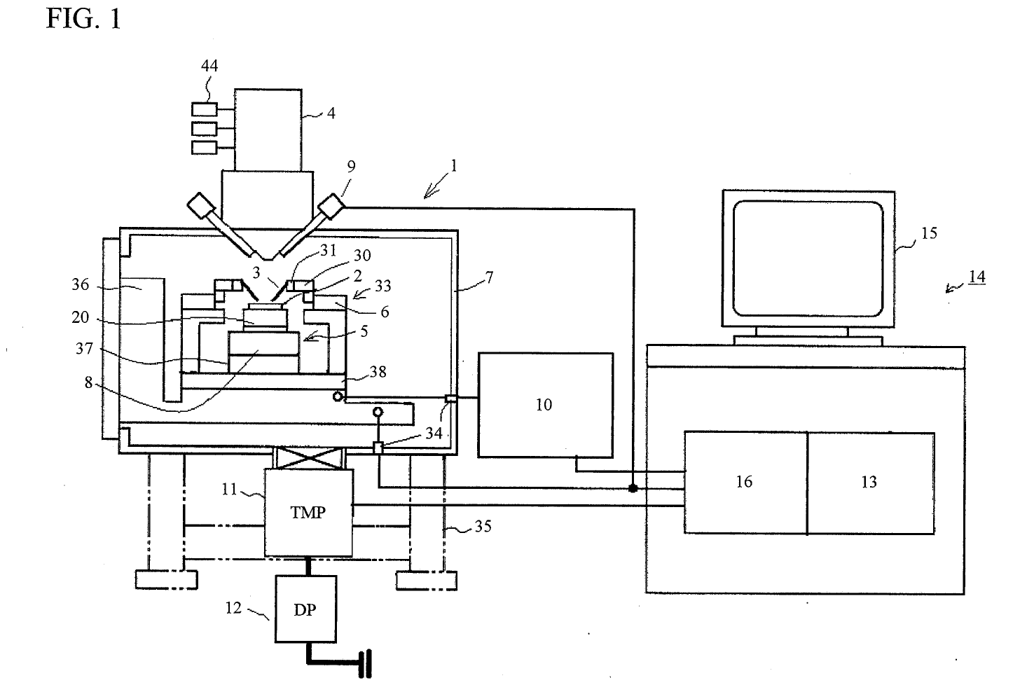

FIG. 1 is a longitudinal cross-sectional view showing a principal part of the SEM type inspection apparatus. The inspection apparatus brings a probe into direct contact with a circuit pattern formed on a semiconductor device to measure the logical operation or the electrical characteristics of a circuit. A SEM type inspection apparatus 1 shown in FIG. 1 includes—in a specimen chamber 7—a stage 5 on which a specimen 2 is mounted, and a probe stage 6 on which a probe unit 33 is mounted. In this embodiment, the probe stage 6 can load the three or more probe units 33. A housing of the specimen chamber 7 is provided with an electro-optic system 4 (e.g., a charged particle system) including a scanning electron microscope (SEM) or an ion pump 44 such as a focused ion beam (FIB). The electro-optic system 4 is disposed opposite to the specimen 2 in order to perform an inspection on the specimen 2. An electric signal acquired by the electro-optic system 4 such as the SEM is transmitted through a controller 16 to a display device 14. The display device 14 displays an image on an image display unit 15.

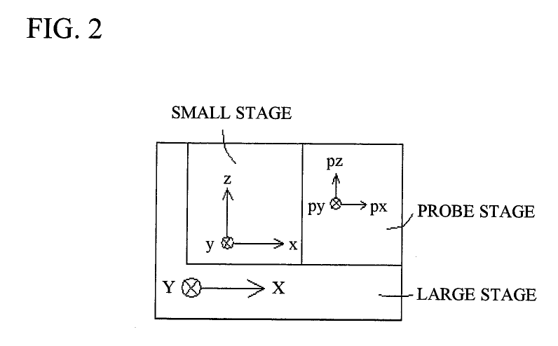

The stage 5 includes: a small stage 37 having triaxial (xyz) travel directions, on which the specimen 2 is mounted; and a large stage 36 having biaxial (XY) travel directions, on which the small stage 37 is mounted. (See FIG. 2.) The probe unit 33 includes: the probe stage 6 that is powered by a piezoelectric device having triaxial (px, py, pz) travel directions; a probe holder 31 that holds a probe 3; and a probe heating unit 30 that heats the probe 3 while holding the probe holder 31. The probe unit 33 is linked to the large stage 36 through a probe unit base 38. The probe unit 33 includes px, py and pz tables (not shown) to allow movements of the probe 3 in three dimensions. Likewise, the small stage 37 includes x, y and z tables (not shown) to allow movements of the specimen 2 in three dimensions. Movements of the large stage 36 in two dimensions in the directions of the X and Y axes also allow movements of the probe stage 6 and the small stage 37 in the directions of the X and Y axes.

The specimen chamber 7 is provided at its top with a Z-sensor 9 of laser focus type, which is disposed to measure focal points (or heights) of the electro-optic system 4 and the specimen 2. The specimen chamber 7 is provided with a field-through 34 so that a signal and power for controlling operation of the probe stage 6 from the controller 16 or a power supply unit 13 are externally fed, and so that a signal and power for controlling operation of the small stage 37 are externally fed. The specimen chamber 7 is connected to a turbo-molecular pump (TMP) 11 and a dry pump (DP) 12 linked to the turbo-molecular pump 11, and the specimen chamber 7 is evacuated in response to a signal from the controller 16 by a utility of the display device 14. The housing of the specimen chamber 7 is supported on a frame 35 having an anti-vibration function, shown by the chain double-dashed lines in FIG. 1.

The inspection apparatus 1 includes the display device 14 having the image display unit 15 and the controller 16. In the inspection apparatus 1, operation information is converted into a control signal by the controller 16 to act as probe and stage operation signals, thereby controlling the probe stage 6 and the stage 5.

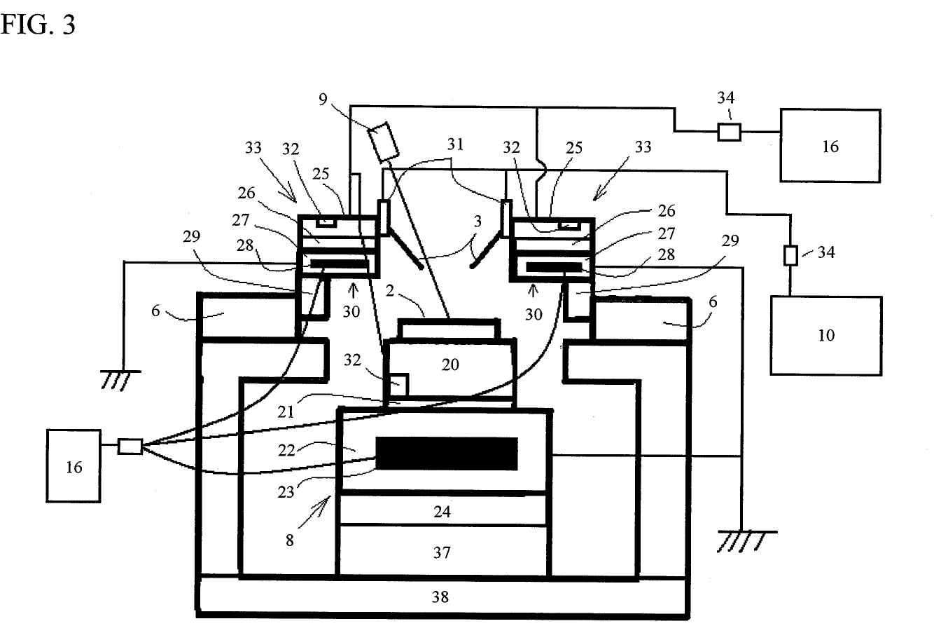

FIG. 3 shows details of the peripheries of the probe unit 33 and a specimen holder 20. The probe heating unit 30 of the probe unit 33 is configured of: an insulating base 29 that provides thermal insulation; a metallic shield 27 having excellent thermal conductivity; a heater 28 built into the shield 27; and an insulation sheet 26 having excellent electrical insulation properties and thermal conductivity. Likewise, a specimen heating unit 8 is configured of: an insulating base 24 that provides thermal insulation; a metallic shield 22 having excellent thermal conductivity and electrical conductivity; a heater 23 built into the shield 22; and an insulation sheet 21 having excellent electrical insulation properties and thermal conductivity. The heaters 28 and 23, the shields 27 and 22, the insulating bases 29 and 24 and the insulation sheets 26 and 21 of the probe heating unit 30 and the specimen heating unit 8 have optimized materials, shapes and thicknesses according to their heat capacities.

For example when a polyimide sheet having a film thickness of 25 μm is used as the insulation sheet, the metallic shield having a thickness of 2.5 mm is used for the heaters 23 and 28 having an amount of heat of 45 W. A probe unit head 25 and the bottom of the specimen holder 20 each include a temperature sensor 32, and its temperature information is transmitted from each of the temperature sensors 32 through the field-through 34 to the controller 16. The temperature information is used to perform heater control of a heating unit power supply. The controller 16 controls the heaters 23 and 28 so that the temperature of the specimen 2 is the same as that of the probe 3, using the temperature information from the temperature sensor 32 provided for the specimen holder 20 as well as the temperature information from the temperature sensor 32 provided for the probe unit head 25.

An electric signal from the probe 3 is fed to an electrical characteristic evaluation unit 10 such as a semiconductor parameter analyzer through the field-through 34. The signal from the probe 3 is analyzed by the electrical characteristic evaluation unit 10, while the electrical characteristic evaluation unit 10 or the image display unit 15 produces displays to express analytical results numerically in graphical or tabular form. It is required that independent electrical insulation properties of the probes 3 of the probe units 33 and electrical insulation properties of the specimen 2, that is, the specimen holder 20, be floating, in order that the inspection apparatus 1 measures electrical characteristics of the specimen 2 with high sensitivity.

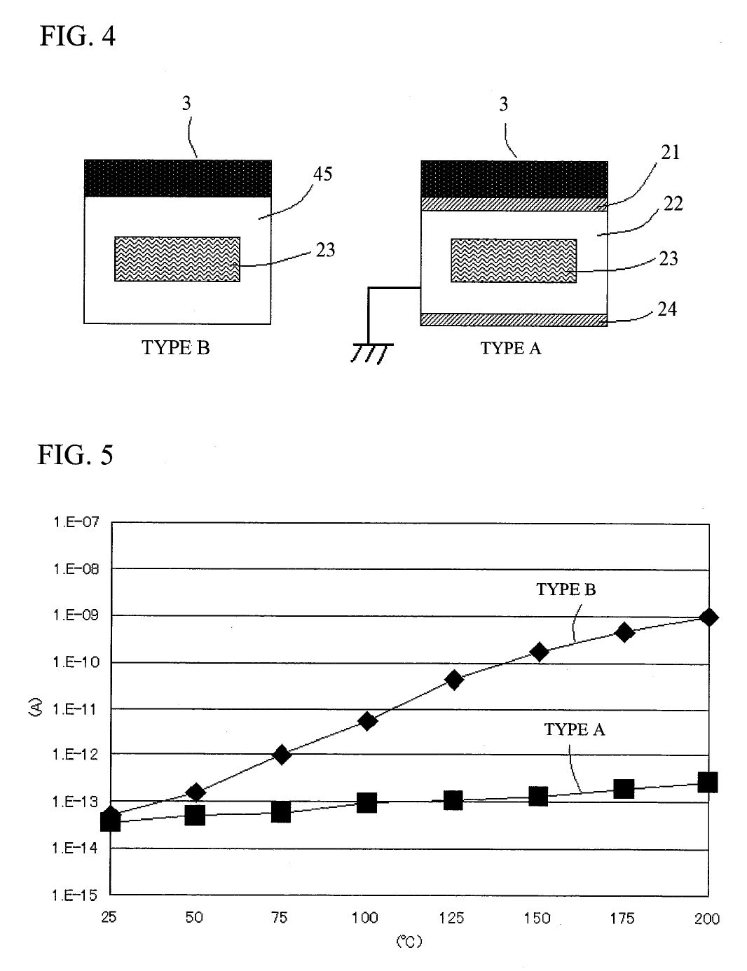

According to the present invention, for example, the specimen heating unit 8 has a construction as shown in FIG. 4 as being of type A, in which the heater 23 is coated with the metallic shield 22 made of copper having excellent thermal conductivity and electrical conductivity, while the potential of the shield is grounded to shut off leak electric current, for the purpose of suppressing the leak electric current from the heater. Electrical insulation is provided between the heater 23 and the metallic shield 22. Moreover, the insulation sheet 21 such as a polyimide-base or silicon-base sheet having excellent electrical insulation properties and thermal conductivity is interposed between the specimen 2 and the metallic shield 22. In this way, the insulating properties of the specimen 2 are ensured, while the thermal conductivity is maintained. Thus, the leak electric current from the heater 23 is suppressed. Moreover, the heaters 28 and 23, the shields 27 and 22, the insulating bases 29 and 24 and the insulation sheets 26 and 21 of the probe heating unit 30 and the specimen heating unit 8 have the optimized materials, shapes and thicknesses in accordance with the heat capacities or types thereof.

In the embodiment, for example, when a polyimide sheet having a film thickness of 25 μm and an area of 20×20 mm is used as the insulation sheet 21, the metallic shield 22 having a thickness of 2.5 mm is used for the heater 23 having an amount of heat of 45 W, resulting in successfully reducing the leak electric current to the order of 100 femtoamperes (fA). The same goes for the probe heating unit 30.

FIG. 5 shows the measured values of leak electric currents according to this embodiment. In FIG. 5, the horizontal axis indicates temperature, and the vertical axis indicates leak electric current. Comparative tests were performed, provided that the construction according to the embodiment is of the type A and the prior art construction is of type B in which an insulating material 45 is used to shut off the leak electric current from the heater as shown in FIG. 4. The same material, e.g., polyimide, was used for insulation. With the prior art construction of the type B, a temperature rise increases the leak electric current from the order of picoamperes (pA) to the order of nanoamperes (nA), whereas with the construction of the type A according to this embodiment, the temperature rise hardly increases the leak electric current, which is of the order of 100 femtoamperes (fA).

As mentioned above, the use of the specimen heating unit 8 and the probe heating unit 30 having the constructions according to the present invention makes it possible to measure highly sensitive electrical characteristics without the leak electric current to the specimen 2 and the probe 3, on the occasion of heating the specimen 2 by the heater 23.

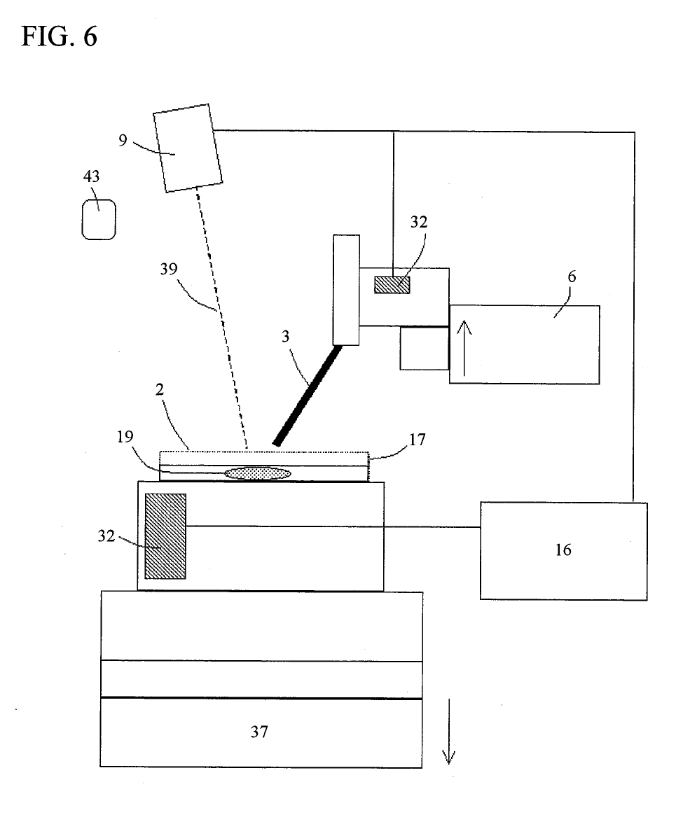

FIG. 6 is a schematic view showing another embodiment of a principal part of the inspection apparatus according to the present invention. The inspection apparatus according to this embodiment includes a probe withdrawing mechanism, in addition to a mechanism that performs temperature control so that the temperature of the specimen 2 is the same as that of the probe 3. Now assume that a drift occurs due to thermal expansion of the specimen 2 resulting from a sharp rise in the temperature of the specimen 2 caused by the passage of electric current through the specimen 2. In this case, the Z-sensor 9 detects the height of the specimen 2, a temperature sensor 43 such as a radiation thermometer detects the temperature of the specimen, and thus the stage 5 or the probe stage 6 powered by the piezoelectric device drives the probe 3 so that the probe 3 is rapidly moved and withdrawn upward as shown by the arrow in FIG. 6. On the occasion of the rise in the temperature of the specimen 2, there is generally a time lag between the occurrence of the rise in the temperature thereof and the occurrence of the drift in the specimen 2 due to the thermal expansion thereof. In this embodiment, therefore, the controller 16 monitors a change in temperature per unit time (e.g., 1 kHz) as in the case of a change in height per unit time (e.g., 1 kHz), and the controller 16 first enters withdrawal sequence operation if there is a preset change in temperature (e.g., 0.1 degree per 0.001 second). For example if there is a sharp change in height (e.g., 0.1 μm per 0.001 second), the probe stage 6 drives the probe 3 so that the probe 3 is rapidly moved and withdrawn upward as shown by the arrow in FIG. 6 by the amount of change in height detected by the Z-sensor 9, that is, in steps of 0.1 μm. If there is a slow change in height (e.g., 0.1 μm per 0.1 second), a specimen stage likewise drives the probe 3 so that the probe 3 is withdrawn in steps of 0.1 μm.

In FIG. 6, reference numeral 19 denotes a schematic representation of a heat generation source in the specimen 2, and reference numeral 17 denotes a schematic representation of a thermal expansion of the specimen 2 caused by the rise in the temperature of the specimen 2. Incidentally, the specimen stage rather than the probe stage 6 may be driven downward as shown by the arrow in FIG. 6 so that the specimen 2 moves away from the probe 3. For example, a sensor that irradiates the surface of the specimen 2 with laser light 39 to measure a distance to the surface of the specimen 2 on the same principle as that of radar can be used as the Z-sensor 9.

The embodiment makes it possible to track a change in temperature in units of 1 kHz (or 0.001 second). As mentioned above, the probe withdrawing mechanism is provided to automatically correct and cancel the drift in the specimen 2 caused by a sharp change in temperature. This enables highly reliable measurement without damage to the probe 3 and thus enables an improvement in operability of the inspection apparatus. Moreover, it goes without saying that a preset temperature to which the specimen 2 is heated is also automatically corrected by the controller 16, if there is a change in the temperature of the specimen 2 caused by self-heating.

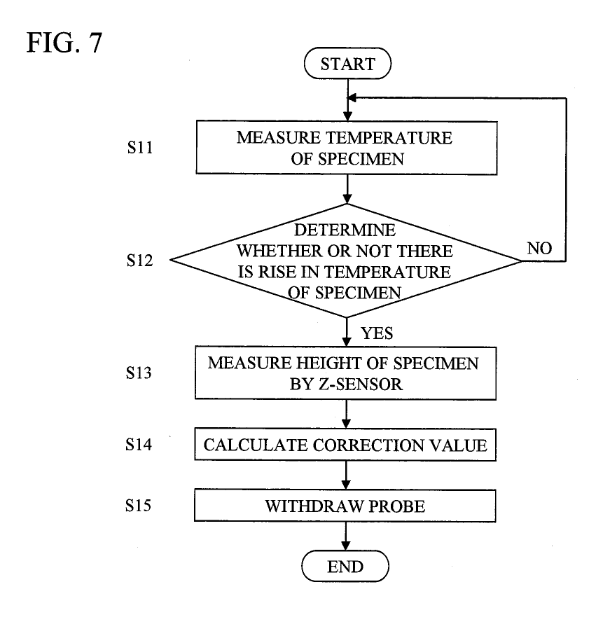

FIG. 7 shows a flowchart of an example of probe withdrawal control. The temperature of the specimen 2 is measured by the temperature sensor 43 (at step S11), and monitoring is performed to determine whether or not there is a rise in the temperature of the specimen 2 caused by the self-heating thereof (at step S12). Whether or not there is a rise in the temperature of the specimen 2 caused by the self-heating thereof can be easily determined because the rise in the temperature manifests itself in the form of a sharp rise in the temperature of the specimen 2. If there is a rise in the temperature of the specimen 2 caused by the self-heating thereof, the height of the specimen 2 is measured by the Z-sensor 9 (at step S13), and a correction value for the withdrawal sequence operation is calculated (at step S14). The probe 3 is withdrawn so as not to come into excessive contact with the specimen 2, by driving the stage or the probe stage 6 in accordance with the rate of change in height, on the basis of the calculated correction value (at step S15).

Description will now be given with regard to calculation of the correction value at step S14. In this embodiment, two methods are used in order to adapt to the rise in the temperature of the specimen 2. The reason for using these methods is that the probe stage 6 is not adaptable to a significant change in temperature because the probe stage 6 has a short stroke of about 5 μm, although the probe stage 6 is capable of rapid withdrawal. On the other hand, the specimen stage makes slower response than the probe stage 6, although the specimen stage has a stroke of the order of millimeters (mm). Specifically, the probe stage 6 is moved and withdrawn if the amount of change in the height of the specimen 2 is 0.1 μm or more per 1 kHz (or 0.001 second). The specimen stage is moved and withdrawn if the amount of change in the height of the specimen 2 is 1 μm or more per 1 Hz (or per second). A sampling interval (or calculation interval) between logical calculations is 1 kHz. The correction value is logically calculated in accordance with the pattern of the rise in the temperature of the specimen 2.

In this embodiment, data is acquired and monitored at intervals of 0.001 second. If the amount of change in the height of the specimen 2 is 0.1 μm or more in the period of 0.001 second, the probe stage 6 is withdrawn in accordance with the amount of change in the height. If the rate of change in the height is 1 μm or more per second, the specimen stage is withdrawn in accordance with the amount of change in the height.

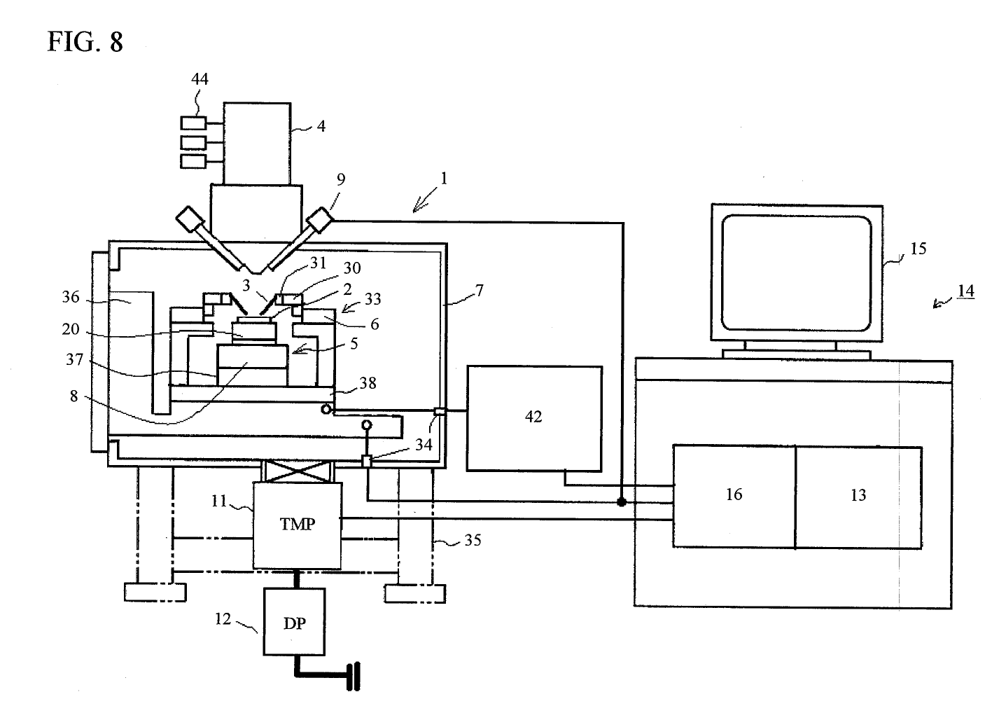

FIG. 8 is a schematic view showing another embodiment of the inspection apparatus according to the present invention. In this embodiment, there is provided a minute signal amplifier 42 in place of the electrical characteristic evaluation unit 10 according to this embodiment shown in FIG. 1. The electric signal from the probe 3 is fed to the controller 16 through the minute signal amplifier 42, and an image is displayed on the image display unit 15 in synchronization with a SEM image from the electro-optic system 4. The image based on the electric signal from the probe 3 is obtained by displaying, in an image form, the intensity of the electric signal (or an electron beam absorption current) from the probe 3 in synchronization with electron beam scanning by the electro-optic system 4.

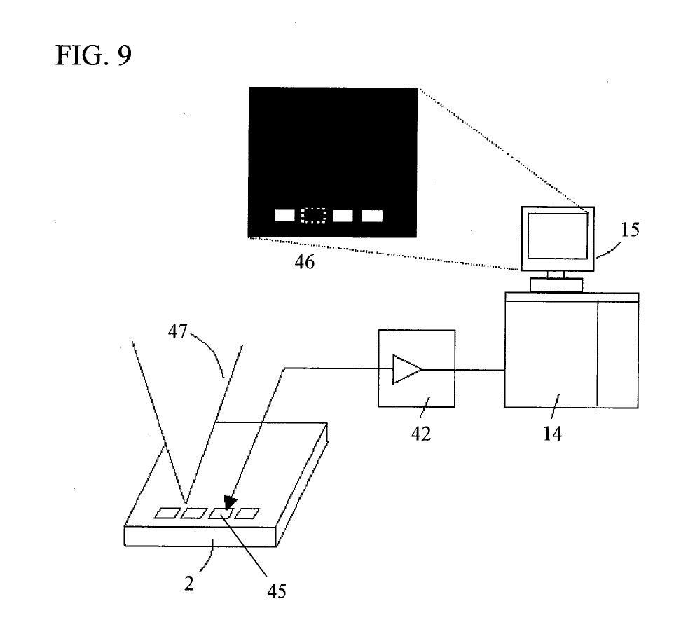

As a result, as shown in FIG. 9, an electron beam absorption current image 46 is displayed on the image display unit 15, and a failure in an electric circuit can be located by the intensity level (or gray level) of the image. In FIG. 9, the electron beam absorption current image 46 is shown as formed by bringing the probe 3 into contact with a pad 45 on the specimen 2, and by scanning the specimen 2 with an electron beam 47. A method disclosed in Japanese Patent Application Laid-Open Publication No. 2005-347773, for example, can be used as a method for displaying, in an image form, the electric signal from the probe 3.

1. An inspection apparatus, comprising:
a specimen chamber;
a probe unit provided within the specimen chamber, the probe unit including a specimen stage on which a specimen having a circuit wiring pattern is mounted, and a probe that is brought into contact with the specimen mounted on the specimen stage; and
an electro-optic system that irradiates the specimen with an electron beam,
wherein the specimen stage includes a specimen heating unit that heats the specimen, the specimen heating unit including a heater, a grounded metallic shield, which coats the heater as electrically insulated, and an insulation member disposed on a side of the metallic shield facing the mounted specimen, and
while the specimen mounted on the specimen stage is heated by the specimen heating unit, the probe of the probe unit is brought into contact with the specimen, whereby electrical characteristics of the circuit wiring pattern of the specimen are measured.

2. The inspection apparatus according to claim 1, wherein the probe unit includes a probe heating unit including a heater, a grounded metallic shield, which coats the heater as electrically insulated, and an insulation member disposed on a side of the metallic shield facing the probe, and the probe heating unit heats the probe through the insulation member.

3. The inspection apparatus according to claim 1, wherein the insulation member is an insulation sheet.

4. The inspection apparatus according to claim 1, wherein the insulation member is made of polyimide.

5. The inspection apparatus according to claim 1, comprising:
a Z-sensor that measures the height of the specimen mounted on the specimen stage; and
a temperature sensor that measures the temperature of the specimen,
wherein a change in the height of the specimen caused by a change in the temperature of the specimen is canceled by driving the probe with any one of the specimen stage and the probe unit.

6. The inspection apparatus according to claim 1, wherein the electro-optic system scans the specimen with the electron beam, and the intensity of current detected by the probe is outputted in synchronization with the scanning of the electron beam and is displayed in an image form.

7. The inspection apparatus according to claim 2, wherein the temperature of the specimen heating unit and the temperature of the probe heating unit are monitored, and are controlled so that both of the temperatures are the same as each other.

8. A sample inspection method, comprising the steps of:
heating a specimen having a circuit wiring pattern mounted on a specimen stage by transferring heat—generated by a heater provided for the specimen stage—through a grounded metallic shield, which coats the heater as electrically insulated, and through an insulation member disposed on a side of the metallic shield facing the mounted specimen;
bringing a probe into contact with the specimen;
scanning the specimen with an electron beam; and
outputting the intensity of current detected by the probe in synchronization with the scanning of the electron beam, and displaying the intensity of current in an image form.

9. The sample inspection method according to claim 8, wherein the probe is heated by transferring heat—generated by a heater—through a grounded metallic shield, which coats the heater as electrically insulated, and through an insulation member disposed on a side of the metallic shield facing the probe.

10. The sample inspection method according to claim 8, comprising the steps of:
measuring a temperature and height of the specimen at predetermined sampling intervals;
starting a withdrawal sequence if detecting a rise in the temperature of the specimen caused by self-heating of the specimen; and
driving the probe in a withdrawing direction if the rate of change in the height of the specimen is not less than a preset value, while driving the specimen stage in a withdrawing direction if the rate of change in the height is less than the preset value, thereby canceling a change in the height of the specimen caused by the self-heating of the specimen by movement of any one of the specimen stage and the probe.
